(19) United States
(12) Patent Application Publication
(10) Pub. No.: US 2014/0316738 A1
(43) Pub. Date: Oct. 23, 2014

(54) APPARATUS AND METHOD FOR MEASURING POSITION OF LIGHT

(71) Applicant: Electronics and Telecommunications Research Institute, Daejeon (KR)

(72) Inventors: Dae-Ho KIM, Daejeon (KR); You-Jin KIM, Daejeon (KR); Hyun-Seok KIM, Daejeon (KR); Hyun-Jong KIM, Cheongju-si Chungcheongbuk-do (KR); Tae-Gyu KANG, Daejeon (KR); Sang-Kyu LIM, Daejeon (KR); Il-Soon JANG, Daejeon (KR); Myung-Soon KIM, Daejeon (KR); Jin-Doo JEONG, Daejeon (KR); Jung-Sik SUNG, Daejeon (KR); Hyun-Chul KANG, Daejeon (KR); Hyun-Joo KANG, Daejeon (KR); Seong-Hee PARK, Daejeon (KR); In-Su KIM, Daejeon (KR); Jong-Woo CHOI, Daejeon (KR)

(73) Assignee: Electronics and Telecommunications Research Institute, Daejeon (KR)

(21) Appl. No.: 14/249,501

(22) Filed: Apr. 10, 2014

(30) Foreign Application Priority Data
Apr. 19, 2013 (KR) 10-2013-0043597

(51) Int. Cl. G01B 11/14

(52) U.S. Cl. CPC G01B 11/14
USPC 702/150

(57) ABSTRACT

An apparatus and a method for measuring a position of a light are disclosed. The apparatus for measuring a position of a light includes: an inputting unit configured to receive position information on a building and a floor in which a user is positioned; a position coordinate calculating unit configured to measure distances between a position of the user and wall surfaces in the building in each direction and calculate a position coordinate of the user based on the distances in each direction; a position determining unit configured to apply the position coordinate to a plan view corresponding to the position information to determine an initial position of the user; and a position information combining unit configured to receive a light identifier depending on movement of the user and store position information of the light corresponding to the light identifier.

### CROSS REFERENCE TO RELATED APPLICATION

This application claims the benefit of Korean Patent Application No. 10-2013-0043597, filed on Apr. 19, 2013, which is hereby incorporated by reference in its entirety into this application.

### BACKGROUND OF THE INVENTION

1. Technical Field

The present invention relates to an apparatus and a method for measuring a position of a light, and more particularly, to an apparatus and a method for measuring a position of a light and providing position information of the light capable of performing visible light wireless communication in a building.

2. Description of the Related Art

Currently, there are several technologies for confirming a current position of a user. Among them, a method for confirming a position of a user using a global positioning system (GPS) has been generally used. However, the method for confirming a position using the GPS has a disadvantage that an error may occur depending on precision of position information provided by a GPS satellite and precision of current time information required for calculating a distance between the GPS satellite and the user. In addition, the technology for confirming a position using the GPS has a disadvantage that a position of the user may not be confirmed when the user stays in a building, that is, the user stays indoors.

In order to solve these disadvantages of the method for tracking a position using the GPS, access information of Wi-Fi or position information of a base station to which a portable terminal of the user is connected may be used. However, in these schemes, the position of the user may be two-dimensionally and approximately judged, but it is difficult to judge three-dimensionally the position of the user. That is, a place at which the user is positioned may be recognized within a preset error range, but it is difficult to receive detailed information on what floor the user stays on and what room the user stays in.

In order to solve these problems of the related art, a technology for tracking a position using visible light communication and a technology for tracking position information of a light used for the visible light communication have been developed. For example, Korean Patent Application Publication No. 2010-0059194 entitled “Visible Light Communication System and Method Using Visible Light ID” has been disclosed. However, in order to provide the technology for tracking a position using visible light communication, current position information should be provided to the light in advance. However, it is difficult to confirm positions of individual lights and it is also difficult for the user to input position information of the lights whenever the lights are installed.

### SUMMARY OF THE INVENTION

Accordingly, the present invention has been made keeping in mind the above problems occurring in the conventional art, and an object of the present invention is to provide an apparatus and a method for accurately creating position information of lights required for a technology for tracking position information of a user using visible light communication and allocating the created position information of the lights to each light.

In accordance with an aspect of the present invention, there is provided an apparatus for measuring a position of a light, including: an inputting unit configured to receive position information on a building and a floor in which a position of a light is to be measured; a position coordinate calculating unit configured to measure distances between a position of a user and wall surfaces in the building in each direction and calculate a position coordinate of the user based on the distances in each direction; a position determining unit configured to apply the position coordinate to a plan view corresponding to the position information to determine an initial position of the user; and a position information combining unit configured to receive a light identifier depending on movement of the user and store position information of the light corresponding to the light identifier.

The position determining unit may include a position searching module configured to request the user to confirm his/her position when candidate positions corresponding to estimated positions of the user are present, thereby determining the initial position of the user.

The position searching module may create reference lines spaced apart from the wall surfaces in the building by the distances in each direction in the plan view and determine contact points between the reference lines to be the candidate positions.

The position searching module may request the user to set the initial position when the candidate positions are not present.

The position information combining unit may create a current position coordinate as a light identifier zone boundary line when the light identifier received through a communicating unit depending on the movement of the user is changed.

The position information combining unit may compare received powers of the light corresponding to the light identifier with each other and store a position coordinate at which a received power of the light is maximum as the position information of the light, when the light identifier received through a communicating unit depending on the movement of the user is not changed.

The position determining unit may request the user to set a special space including a single light when the special space is present in the plan view.

The position determining unit may include: an azimuth calculating module configured to receive an azimuth through a geomagnetism sensing module; and a plan view analyzing module configured to analyze the wall surfaces in the building in the plan view received from a plan view storing module.

The position coordinate calculating unit may include: a module of calculating distances in each direction configured to calculate distances between the position of the user and a front wall surface facing the user, a left wall surface positioned at the left of the user, and a right wall surface positioned at the right of the user in each direction, through a distance sensing module; and a module of correcting distance errors in each direction configured to measure gradients for the front wall surface, the left wall surface, and the right wall surfaces through a gradient sensing module and correct errors for the distances in each direction based on the gradients, when a precision measurement request is received from the user.

In accordance with another aspect of the present invention, there is provided a method for measuring a position of a light, including: an inputting unit receiving position information on a building and a floor in which a position of a light is to be measured; a position coordinate calculating unit measuring distances between a position of a user and wall surfaces in the building in each direction and calculating a position coordinate of the user based on the distances in each direction; a position determining unit applying the position coordinate to a plan view corresponding to the position information to determine an initial position of the user; and a position information combining unit receiving a light identifier depending on movement of the user and storing position information of the light corresponding to the light identifier.

The determining of the initial position of the user may include: a position searching module requesting the user to confirm his/her position when candidate positions corresponding to estimated positions of the user are present, thereby determining the initial position of the user.

The determining of the initial position of the user may include: creating reference lines spaced apart from the wall surfaces in the building by the distances in each direction in the plan view and determining contact points between the reference lines to be the candidate positions.

The determining of the initial position of the user may include: requesting the user to set the initial position when the candidate positions are not present.

The storing of the position information of the light may include: creating a current position coordinate as a light identifier zone boundary line when the light identifier received through a communicating unit depending on the movement of the user is changed.

The storing of the position coordinate of the light may include: comparing received powers of the light corresponding to the light identifier with each other and storing a position coordinate at which a received power of the light is maximum as the position information of the light, when the light identifier received through a communicating unit depending on the movement of the user is not changed.

The determining of the initial position of the user may include: requesting the user to set a special space including a single light when the special space is present in the plan view.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a flow chart of a method for measuring a position of a light according to an embodiment of the present invention;

FIG. 2 is a flow chart of a step of calculating a position coordinate of a user included in the method for measuring a position of a light according to an embodiment of the present invention;

FIG. 3 is a diagram showing an example of a step of correcting distances in each direction at a step of calculating a position coordinate of a user;

FIG. 4 is a flow chart of a step of determining an initial position of a user included in the method for measuring a position of a light according to an embodiment of the present invention;

FIG. 5 is a flow chart of a step of searching candidate positions performed at a step of determining an initial position of a user;

FIG. 6 is a diagram showing an example in which the candidate positions are searched by a step of searching candidate positions;

FIG. 7 is a flow chart of a step of storing position information of a light included in the method for measuring a position of a light according to an embodiment of the present invention; and

FIG. 8 is a block diagram of an apparatus for measuring a position of a light according to an embodiment of the present invention.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated to make the description clearer.

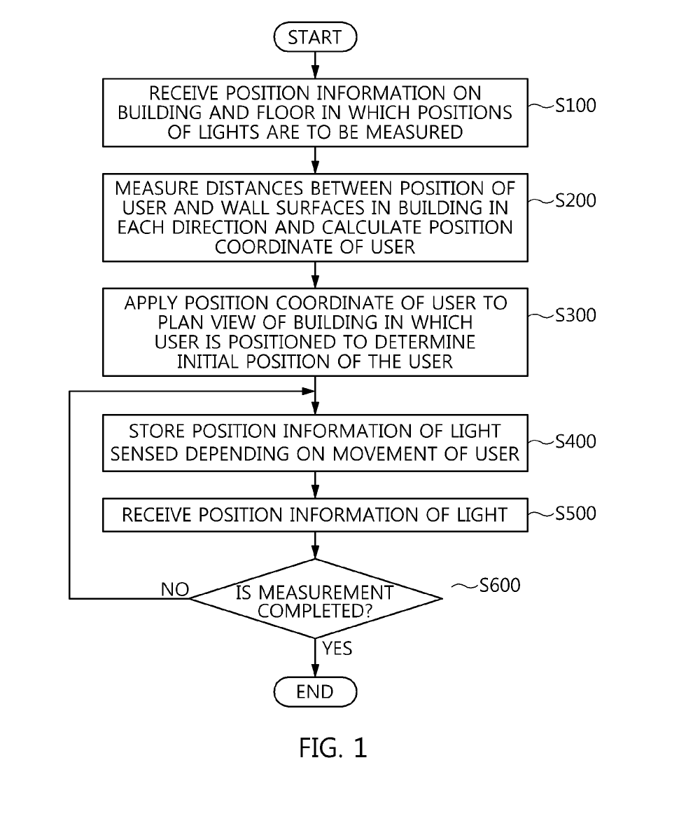

FIG. 1 is a flow chart of a method for measuring a position of a light according to an embodiment of the present invention. Hereinafter, a method for measuring a position of a light according to an embodiment of the present invention will be described with reference to FIG. 1.

First, step S100 of receiving position information on a building and a floor in which positions of lights are to be measured through an inputting unit is performed. At step S100, the received position information may be, for example, schematic information such as address and floor information of the building.

Then, step S200 of measuring distances between a position of a user and wall surfaces in each direction and calculating a position coordinate of the user based on the distances in each direction through a position coordinate calculating unit is performed. In detail, at step S200, first, when the user carrying an apparatus for measuring a position of a light according to an embodiment of the present invention is positioned in the building, distances between a current position of the user and a front wall surface facing the user, a left wall surface positioned at the left of the user, and a right wall surface positioned at the right of the user in each direction are measured using a distance sensing module. A current position coordinate of the user is calculated based on the distances in each direction calculated as described above.

In addition, at step S200, when the user makes a precise measurement request in order to obtain a more accurate measurement result, gradients for the front wall surface, the left wall surface, and the right wall surface are measured using a gradient sensing module. Then, errors for the distances in each direction are corrected based on the measured gradients. In detail, the errors may be corrected using a cosine law of a right-angled triangle. When the errors are corrected as described above, more accurate distance values between the current position of the user and the wall surfaces in the building may be calculated.

Then, step S300 of applying the position coordinate to a plan view corresponding to a plan view to the position information to determine an initial position of the user through a position determining unit is performed. Here, the initial position indicates a position on the plan view corresponding to an actual position of the user. In detail, at step S300, first, an azimuth is received through a geomagnetism sensing module, and wall surfaces of a corresponding floor in the building on a plan view received from a plan view storing module are analyzed. Then, the azimuth and the position coordinate of the user calculated at step S200 are applied to the analyzed plan view. Therefore, the initial position of the user may be determined based on the plan view.

At step S300, at the time of determining the current position of the user, there may be a method in which the user directs sets his/her position on the plan view and a method in which candidate positions corresponding to positions of the user estimated through the apparatus for measuring a position of a light is displayed to the user to allow the user to select his/her position. Here, in the method of using the candidate positions, first, reference lines spaced apart from the wall surfaces in the building by the distances in each direction may be created in the plan view, and the candidate positions may be determined using contact points between the reference lines. When the candidate positions are determined as described above, the initial position of the user may be set through a confirmation procedure of the user. Further, in the method of using the candidate positions, when the candidate positions are not determined through the apparatus for measuring a position of a light, it is possible to request the user to directly set the initial position.

In addition, at step S300, when a special space that includes a single light or is narrow is present in the plan view, it is possible to request the user to directly set the special space.

Then, step S400 of receiving a light identifier depending on movement of the user and storing position information of the light corresponding to the light identifier through a position information combining unit is performed. At step S400, first, the light identifier may be received, and the position information of the light corresponding to the light identifier may be obtained based on the received light identifier and the current position of the user.

In detail, at step S400, when the position information of the light is obtained, a received power of the light corresponding to the received light identifier is changed depending on the movement of the user. That is, at step S400, a position coordinate at which a magnitude of the received power is maximum depending on the movement of the user is stored as the position information of the light. In addition, at step S400, when the light identifier received depending on the movement of the user is changed, a current position coordinate may be created as a light identifier zone boundary line. Therefore, a reception range of one light and reception ranges of other lights depending on the movement of the user may be distinguished from each other.

Then, step S500 of transmitting the position information of the light created at step S400 is performed. The position information of the light may be transmitted to each light and managing server corresponding of the position information of the light.

Then, step S600 of requesting the user to confirm whether additional measurement is to be performed is performed. At step S600, when the user inputs that the additional measurement is to be performed, a control returns to step S400. Otherwise, the control is transferred to an end block, such that all processes end.

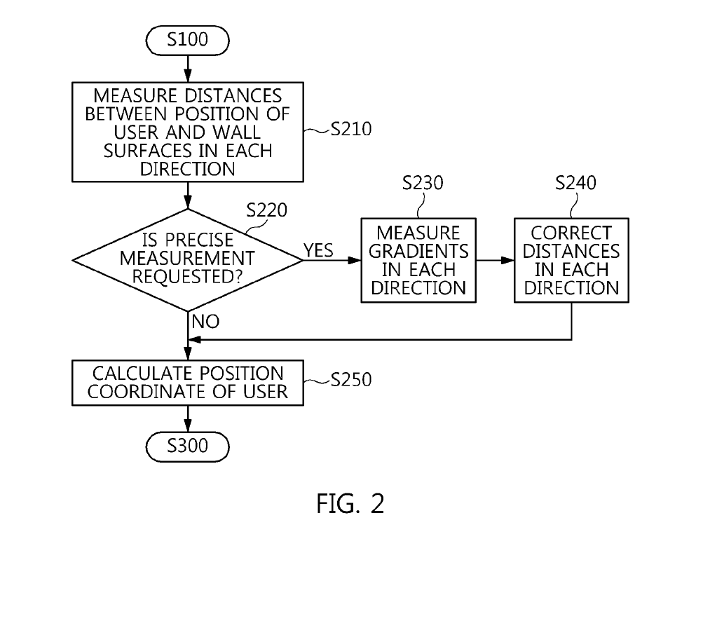

FIG. 2 is a flow chart of a step of calculating a position coordinate of a user included in the method for measuring a position of a light according to an embodiment of the present invention. Hereinafter, a step of calculating a position coordinate of a user will be further described with reference to FIG. 2.

First, step S210 of measuring the distances between the current position of the user and the wall surfaces in the building in each direction, described above with reference to FIG. 1, is performed. In detail, the distances between the current position of the user and the front wall surface facing the user, the left wall surface positioned at the left of the user, and the right wall surface positioned at the right of the user in each direction are measured using the distance sensing module.

Then, step S220 of confirming whether the user makes the precise measurement request is performed. Here, in the precise measure, when the distances in each direction are measured, gradients may be generated depending on measurement directions of a device. The precision measurement is a method for correcting an error that may occur due to the gradient. When the user makes the precise measurement request at step S220, a control is transferred to step S230. Otherwise, the control is transferred to step S250.

Step S230 is a step of measuring the gradients for each of the front wall surface, the left wall surface, and the right wall surface using the gradient sensing module.

Then, step S240 of correcting the errors for the distances in each direction based on the measured gradients is performed. Here, in order to correct the errors, the distances in each direction are calculated using the cosine law of the right-angled triangle.

Step S250 is a step of calculating the position coordinate of the user based on the distances in each direction measured at step S210 or the distances in each direction corrected at step S240. When the position coordinate of the user is calculated as described above, the control is transferred to step S300.

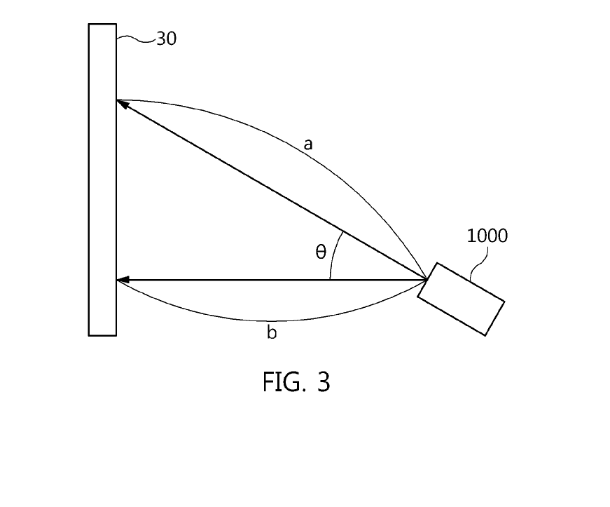

FIG. 3 is a diagram showing an example of a step of correcting distances in each direction at a step of calculating a position coordinate of a user. Hereinafter, a step of calculating a position coordinate of a user will be further described with reference to FIG. 3.

In detail, FIG. 3 shows an example of a step performed when the user makes the precise measurement request at step S220 of FIG. 2. When a distance up to a wall surface is measured by the apparatus 1000 for measuring a position of a light shown in FIG. 3, a gradient θ may be generated as shown in FIG. 3. When the distance up to the wall surface 30 is measured in a state in which the gradient θ is present, the distance is measured as a length corresponding to a line a. This error may be corrected using the cosine law of the right-angled triangle. That is, when the length of the line a measured by the distance sensing module and the gradient θ measured through the gradient sensing module are used, an actual length value of a line b up to the wall surface 30 may be calculated.

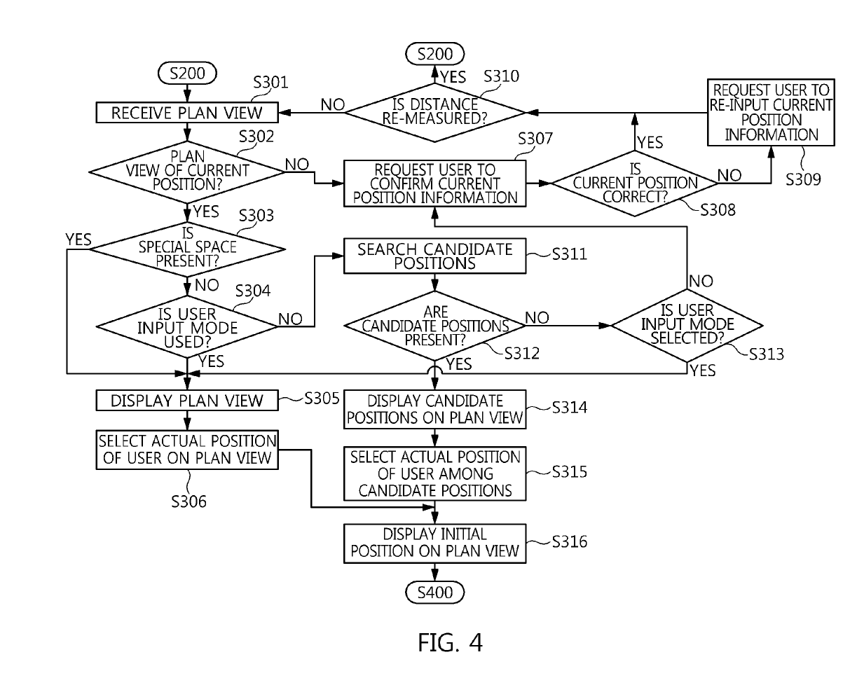

FIG. 4 is a flow chart of a step of determining an initial position of a user included in the method for measuring a position of a light according to an embodiment of the present invention. Hereinafter, a step of determining an initial position of a user will be further described with reference to FIG. 4.

First, step S301 of calling and receiving the plan view corresponding to the position information of the user from the plan view storing module is performed.

Then, step S302 of confirming to the user whether the plan view received at step S301 is a plan view of the current position is performed. At this step, when the user inputs that the received plan view is the plan view of the current position, a control is transferred to step S303. Otherwise, the control is transferred to step S307.

Step S303 is a step of confirming whether a special space is position in the plane view. Here, the special space, which is a single space in an entire space, means a space that is narrow or includes a single light. When it is judged at step S303 that the special space is present, the control is transferred to step S305. Otherwise, the control is transferred to step S304.

Step S304 is a step of confirming to the user whether the user is to use a user input mode. Here, the user input mode is not a scheme of using the candidate positions described above with reference to FIG. 1, but is a scheme in which the user directly sets the position in the plan view. When the user inputs that he/she uses the user input mode, the control is transferred to step S305. Otherwise, the control is transferred to step S311.

Step S305 is a step of displaying the plan view to the user. Therefore, the user may confirm a form of the building in which the user is positioned through a displaying unit.

Then, step S306 of selecting the actual position of the user on the plan view is performed. Here, the selected position of the user is used as the initial position of the user described above. In addition, at step S306, the input of the special space described above may also be performed.

Step S307, which is performed when the plan view received at step S301 is not correct, is a step of requesting the user to confirm whether the current position information has been correctly input.

Then, step S308 of inputting whether the current position has been correctly input is performed. When it is input at step S308 that the current position is correct, the control is transferred to step S310. Otherwise, the control is transferred to step S309.

Step S309 is a step of requesting the user to re-input the current position information. The error that may occur through an erroneous user input at step S100 of FIG. 1 may be corrected through the re-input request.

Then, step S310 of requesting the user to confirm whether the distances between the user and the wall surfaces in the building are to be re-measured through step S200 is performed. Here, when the user inputs that the distances are to be re-measured, the control returns to step S200, such that steps described above with reference to FIGS. 1 and 2 are again performed. Otherwise, the control is transferred to step S301.

Step S311, which is performed when it is determined at step S304 that the user input mode is not used, is a step of searching the candidate positions at which it is estimated that the user will be positioned in the building.

Then, step S312 of determined whether the candidate positions searched at step S311 are present is performed. When it is determined at step S312 that the candidate positions are present, the control is transferred to step S314. Otherwise, the control is transferred to step S313.

Step S313, which is performed when the candidate positions are not searched at step S312, is a step of confirming whether the user directly selects his/her current position through the user input mode. Here, when the user inputs that he/she uses the user input mode, the control is transferred to step S305, and the above-mentioned step S305 is performed. When the user inputs that he/she does not use the user input mode at step S313, the control is transferred to step S307, and the above-mentioned step S307 is performed.

Step S314, which is performed when it is judged at step S312 that the candidate positions are present, is a step of displaying the candidate positions on the plan view. That is, at step S314, the candidate positions are displayed on the plan view to inform the user of the candidate positions.

Then, step S315 of selecting the actual position of the user among the candidate positions is performed. Here, when the number of candidate positions is one, the initial position may be determined through confirmation of the user. In addition, when a plurality of candidate positions are present on the plan view, the actual position of the user may be selected among the plurality of candidate positions by the user.

Step S316 is a step of displaying the position of the user selected at step S306 or step S315 on the plan view. Then, the control is transferred to step S400.

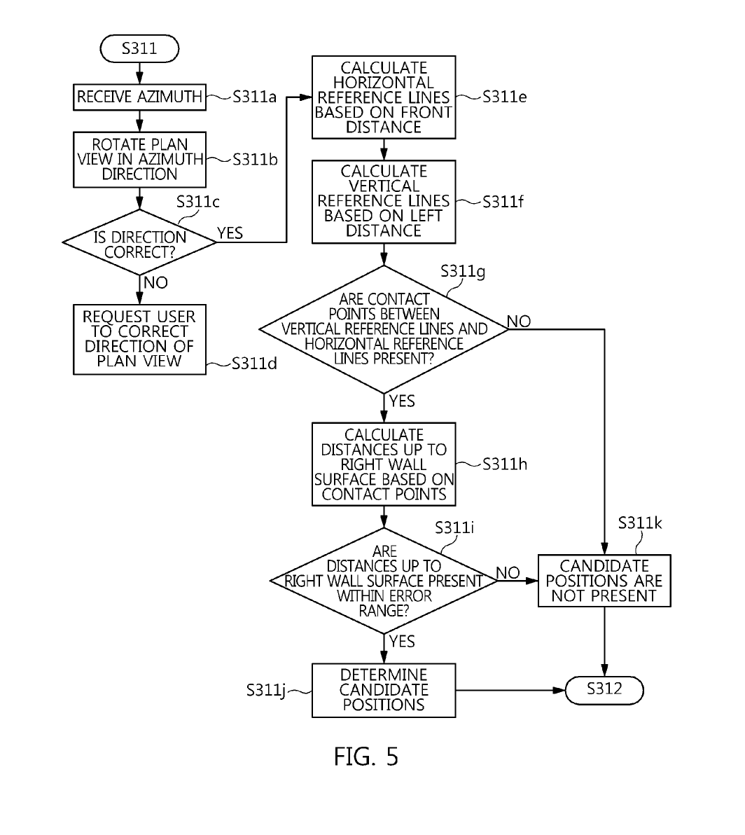

FIG. 5 is a flow chart of a step of searching candidate positions performed at a step of determining an initial position of a user. Hereinafter, a step of searching candidate positions described in FIG. 4 will be further described with reference to FIG. 5.

First, step S311a of receiving the azimuth sensed through the geomagnetism sensing module is performed.

Then, step S311b of rotating the plan view based on a direction of the azimuth received at step S311a is performed. In addition, the rotated plan view may be displayed to the user to allow the user to confirm the rotated plan view.

Then, step S311c of confirming to the user whether a direction of the rotated plan view is correct is performed. At step S311c, since an error may occur in the azimuth sensed by the geomagnetism sensing module, a confirming process by the user is performed in order to make a result more accurate. Here, when the direction is correctly designated, a control is transferred to step S311e. Otherwise, the control is transferred to step S311d.

Step S311d is a step of requesting the user to correct the direction of the plan view. Since the error for the azimuth sensed through the geomagnetism sensing module may be corrected through step S311d, the candidate positions may more accurately be measured.

Step S311e is a step of calculating horizontal reference lines based on a front distance between the user and the front wall surface facing the user. That is, at step S311e, the horizontal reference lines for horizontal wall surfaces present in the plan view are calculated based on the front distance.

Step S311f is a step of calculating vertical reference lines based on a left distance between the user and the left wall surface positioned at the left of the user. That is, at step S311f, the vertical reference lines for vertical wall surfaces present in the plan view are calculated based on the left distance.

Then, step S311g of confirming whether contact points between the horizontal reference lines calculated at step S311e and the vertical reference lines calculated at step S311f are present is performed. Here, when it is judged that the contact points are present, the control is transferred to step S311h. Otherwise, the control is transferred to step S311k.

Step S311h is a step of calculating distances up to the right wall surface based on positions of the contact points confirmed at step S311g.

Then, step S311i of confirming whether the distances calculated at step S311h are present within an error range is performed. That is, the distance between the user and the right wall surface positioned at the right of the user as described above with reference to FIGS. 1 and 2 and the distances up to the right wall surface based on the contact points calculated at step S311h may be compared with each other to confirm whether or not the candidate positions are present. When the distances up to the right wall surface based on the contact points calculated at step S311h are present within an error range, the control is transferred to step S311j to determine the candidate positions. Otherwise, the control is transferred to step S311k to determine that the candidate positions are not present. Then, the control is transferred to step S312.

In addition, it is to be understood that a process of confirming the candidate positions performed through step S311e to step S311h is described by way of example. That is, the reference lines spaced apart from the wall surfaces in the building by the distances in each direction are created in the plan view, and the contact points between the reference lines are determined to be the candidate positions. Therefore, although only a technology of creating the reference lines based on the front distance and the left distance and determining the candidate positions through the comparison between the contact points between the reference lines and the right distances has been described in an embodiment of the present invention, it is to be understood that another method is also possible. For example, it is to be understood that it is also possible to create the reference lines using the front distance and the right distance and determining the candidate positions through comparison between the contact points between the reference lines and the left distances.

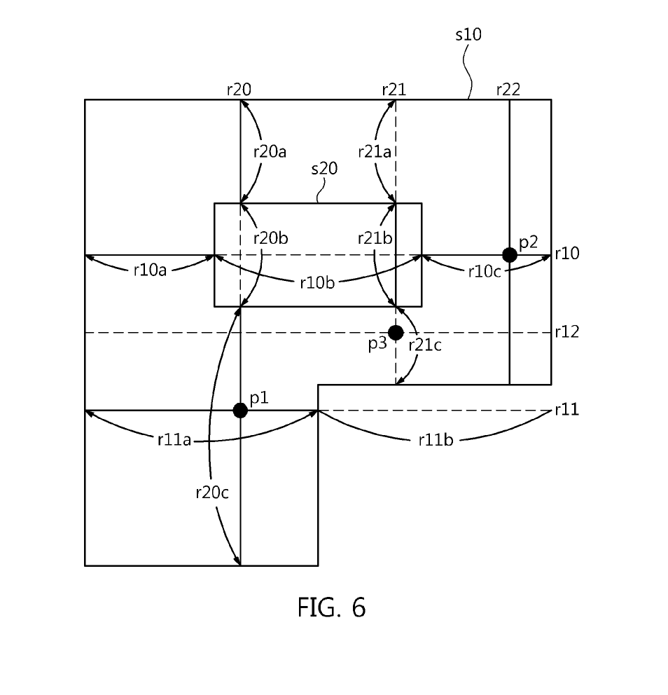

FIG. 6 is a diagram showing an example in which the candidate positions are searched by a step of searching candidate positions. FIG. 6 shows an example of a plan view of a floor in a building in which the user is positioned. Hereinafter, an example of searching the candidate positions will be described with reference to FIG. 6.

Referring to the plan view in this example, a space s10 is present at a place at which the user is positioned, and a space s20 configured of four wall surfaces is present in the space s10. As described above with reference to FIG. 5, horizontal reference lines r10, r11, and r12 are created based on the wall surfaces. Here, the horizontal reference line r10 is created based on an upper wall surface of the space s10, and the horizontal reference line r11 is created based on a lower wall surface of the space s20. Here, since the horizontal reference line r12 created based on an upper wall surface of the space s20 is created at a position that is out of the space s20, it is not used as a reference line.

Then, vertical reference lines r20, r21, and r22 are created based on left distances. Here, the vertical reference line r20 is created based on a left wall surface of the space s10, the vertical reference line r21 is created based on a left wall surface of the space s20, and the vertical reference line r22 is created based on a right wall surface of the space s20.

Then, contact points between the created horizontal reference lines r10 and r11 and vertical reference lines r20, r21, and r22 are confirmed. In this example, two contact points p1 and p2 are present. Here, a contact point p3 is not used as a contact point since the horizontal reference line r12 and the vertical reference line r21 are out of the space s20. Final candidate positions are determined through the comparison between the right distance, the contact points, and the right wall surfaces described above with reference to FIGS. 1 and 2.

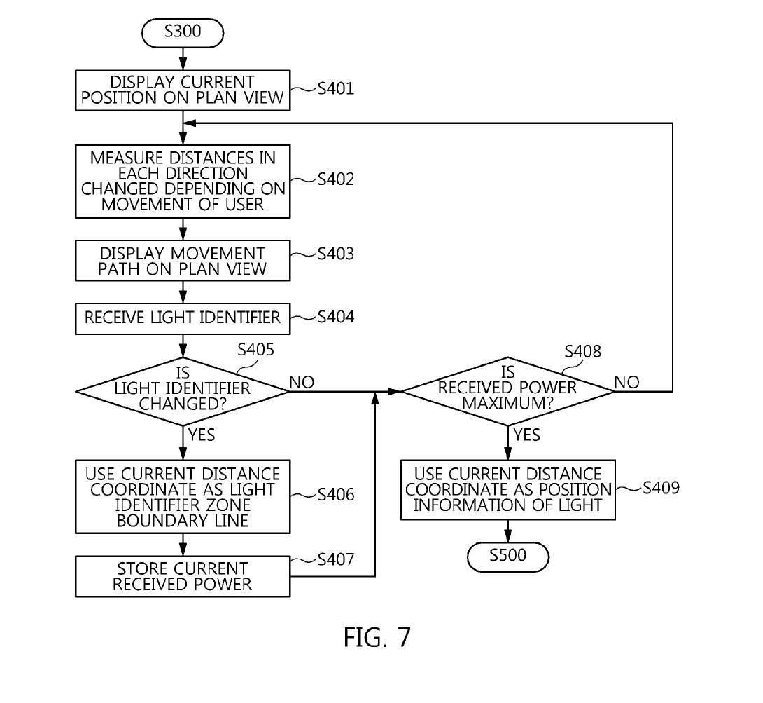

FIG. 7 is a flow chart of a step of storing position information of a light included in the method for measuring a position of a light according to an embodiment of the present invention. Hereinafter, a step of storing position information of a light will be further described with reference to FIG. 7.

First, step S401 of displaying the initial position of the user set at step S300 on the plan view is performed.

Then, step S402 of measuring the distances in each direction changed depending on the movement of the user is performed. That is, step S402 is a step of measuring distances between the user and the wall surfaces in the building changed depending on the movement of the user from the initial position of the user. At step S402, the distances in each direction may be measured as described above with reference to FIGS. 1 and 2.

Then, step S403 of displaying a movement path of the user based on the change in distance values measured at step S402 on the plan view is performed.

Then, step S404 of receiving the light identifier is performed. The light identifier received at step S404 means a light identifier received at the current position of the user. In addition, when a plurality of light identifiers are sensed, a signal having the highest received power may be sensed as the light identifier. In addition, when the plurality of light identifiers are sensed, the light identifier may be designated through selection of the user.

Then, step S405 of judging whether the light identifier is changed depending on the movement of the user is performed. That is, at step S405, it is determined whether the light identifier sensed at step S404 is changed into another light identifier for another light. When it is determined at step S405 that the light identifier is changed, a control is transferred to step S406. Otherwise, the control is transferred to step S408.

Step S406 is a step of using a current distance coordinate at which the light identifier is changed as a light identifier zone boundary line. That is, the light identifier zone boundary line means a boundary line between a light identifier for an existing light and a light identifier for a new light. The light identifier zone boundary line may be used as a boundary line for a range in which one light is used.

Then, step S407 of storing a received power at a point at which the light identifier is changed is performed.

Step S408 is a step of determination whether the received power for the light identifier is maximum. In detail, at step S408, the received power for the light identifier is compared with a value pre-stored for the corresponding light identifier to judge whether the received power for the light identifier on the current distance coordinate is maximum. When it is determined at step S408 that the received power for the light identifier is the maximum, the control is transferred to step S409. Otherwise, the control is transferred to step S402, such that the above-mentioned steps are again performed.

Step S409 is a step of using the current distance coordinate at which the received power is the maximum as the position information of the light corresponding to the light identifier. That is, since a point at which the received power is the maximum is a central portion of the light corresponding to the light identifier, this point may be used as the position information of the light. Then, the control is transferred to step S500.

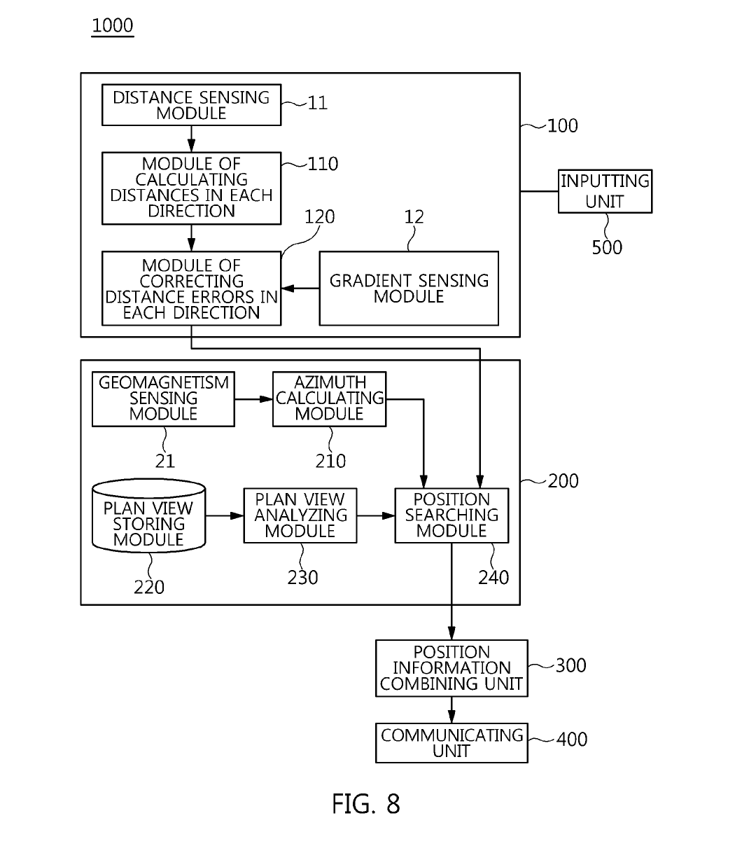

FIG. 8 is a block diagram of an apparatus for measuring a position of a light according to an embodiment of the present invention. Hereinafter, an apparatus for measuring a position of a light according to an embodiment of the present invention will be described with reference to FIG. 8. As shown in FIG. 8, the apparatus 1000 for measuring a position of a light according to an embodiment of the present invention is configured to include a position coordinate calculating unit 100, a position determining unit 200, and a position information combining unit 300. In addition, the apparatus 1000 for measuring a position of a light according to an embodiment of the present invention may further include a communicating unit 400 and an inputting unit 500. The respective components included in the apparatus 1000 for measuring a position of a light according to an embodiment of the present invention will be described below in detail.

The inputting unit 500 serves to receive position information on a building, a floor, and an address in which a user measures a position of a light.

The position coordinate calculating unit 100 serves to measure distances between a position of the user and wall surfaces in the building in each direction and calculate a position coordinate of the user based on the distances in each direction. The position coordinate calculating unit 100 may be configured to include a distance sensing module 11, a gradient sensing module 12, a module 110 of calculating distances in each direction, and a module 120 of correcting distance errors in each direction.

The module 110 of calculating distances in each direction serves to measure the distances between the position of the user and the wall surfaces in each direction in a floor in which the user is positioned, through the distance sensing module 11. In detail, the module 110 of calculating distances in each direction measures distances between a position of a user carrying the apparatus 1000 for measuring a position of a light according to an embodiment of the present invention and a front wall surface, a left wall surface, and a right wall surface in each direction. Here, the reason why a rear distance is not measure is that the user may obstruct the apparatus 1000 for measuring a position of a light and the position of the user may be judged by only a front distance, a left distance, and a right distance.

The module 120 of correcting distance errors in each direction serves to correct errors that may occur in the distances in each direction measured by the module 110 of calculating distances in each direction, through the gradient sensing module 12. Here, the error correction is performed when the user requests precision measurement. The module 120 of correcting distance errors in each direction may measure gradients between the apparatus 1000 for measuring a position of a light and the wall surfaces and then correct the error for the distances in each direction measured through the module 110 of calculating distances in each direction, depending on a cosine law of a right-angled triangle.

The position determining unit 200 serves to apply the position coordinate calculated by the position coordinate calculating unit 100 to a plan view to determine an initial position of the user. The position determining unit is configured to include a geomagnetism sensing module 21, an azimuth calculating module 210, a plan view analyzing module 230, and a position searching module 240.

The azimuth calculating module 210 serves to calculate an azimuth through the geomagnetism sensing module 21.

The plan view analyzing module 230 serves to receive a plan view for the floor in which the user is positioned from a plan view storing module 220 and analyze wall surfaces in the plan view.

The position searching module 240 serves to apply the azimuth calculated by the azimuth calculating module 210 and the position coordinate calculated by the position coordinate calculating unit 100 to the plan view to determine the initial position of the user.

Here, as a method of determining the initial position, there are a method in which the user directly inputs his/her initial position on the plan view and a method in which the initial position is set based on candidate positions determined by the position searching module 240. In the method of using the candidate positions, the determined candidate positions are displayed on the user, such that the initial position of the user may be set through position confirmation of the user. Since the method of determining the initial position has been described in detail with reference to FIGS. 4 to 6, a description thereof will be omitted in order to make the present specification clear.

In addition, the position searching module 240 may request the user to set a position for a special space that includes a signal light or is narrow when the special space is present in the plan view.

The position information combining unit 300 serves to receive a light identifier depending on movement of the user and store position information of the light corresponding to the light identifier. That is, the position information combining unit 300 may receive the light identifier and obtain the position information of the light corresponding to the light identifier based on the received light identifier and the current position of the user.

In detail, when the position information combining unit 300 receives the position information of the light, a received power of the light corresponding to the received light identifier is changed depending on the movement of the user. That is, the position information combining unit 300 stores a position coordinate at which a magnitude of the received power is maximum depending on the movement of the user as the position information of the light. In addition, the position information combining unit 300 may create a current position coordinate as a light identifier zone boundary line when the light identifier received depending on the movement of the user is changed. Therefore, a reception range of one light and reception ranges of other lights depending on the movement of the user may be distinguished from each other.

The communicating unit 400 serves to transmit the position information of the light created by the position information combining unit 300 to a server or the corresponding light.

With the apparatus and the method for measuring a position of a light according to the present invention, the user inputs the position information, and the position information of the lights in the building are measured and transmitted to each of the light, such that the positions of the lights may be accurately input with respect to each of the lights. In addition, accuracy of measurement of an indoor position may be increased through visible light communication using this position information.

Hereinabove, embodiments of the present invention have been disclosed in the accompanying drawings and the specification. In the present specification, although specific terms have been used, they are used only in order to describe the present invention and are not used in order to limit the meaning or the scope of the present invention, which is disclosed in the appended claims. Therefore, it is to be understood by those skilled in the art that various modifications are made and other equivalent embodiments are possible. Accordingly, an actual technical scope of the present invention is to be determined by the spirit of the appended claims.

What is claimed is:

1. An apparatus for measuring a position of a light, comprising:
an inputting unit configured to receive position information on a building and a floor in which a position of a light is to be measured;
a position coordinate calculating unit configured to measure distances between a position of a user and wall surfaces in the building in each direction and calculate a position coordinate of the user based on the distances in each direction;
a position determining unit configured to apply the position coordinate to a plan view corresponding to the position information to determine an initial position of the user; and
a position information combining unit configured to receive a light identifier depending on movement of the user and store position information of the light corresponding to the light identifier.

2. The apparatus for measuring a position of a light of claim 1, wherein the position determining unit comprises a position searching module configured to request the user to confirm his/her position when candidate positions corresponding to estimated positions of the user are present, thereby determining the initial position of the user.

3. The apparatus for measuring a position of a light of claim 2, wherein the position searching module creates reference lines spaced apart from the wall surfaces in the building by the distances in each direction in the plan view and determines contact points between the reference lines to be the candidate positions.

4. The apparatus for measuring a position of a light of claim 2, wherein the position searching module requests the user to set the initial position when the candidate positions are not present.

5. The apparatus for measuring a position of a light of claim 1, wherein the position information combining unit creates a current position coordinate as a light identifier zone boundary line when the light identifier received through a communicating unit depending on the movement of the user is changed.

6. The apparatus for measuring a position of a light of claim 1, wherein the position information combining unit compares received powers of the light corresponding to the light identifier with each other and stores a position coordinate at which a received power of the light is maximum as the position information of the light, when the light identifier received through a communicating unit depending on the movement of the user is not changed.

7. The apparatus for measuring a position of a light of claim 1, wherein the position determining unit requests the user to set a special space including a single light when the special space is present in the plan view.

8. The apparatus for measuring a position of a light of claim 1, wherein the position determining unit comprising:
an azimuth calculating module configured to receive an azimuth through a geomagnetism sensing module; and
a plan view analyzing module configured to analyze the wall surfaces in the building in the plan view received from a plan view storing module.

9. The apparatus for measuring a position of a light of claim 1, wherein the position coordinate calculating unit comprising:
a module of calculating distances in each direction configured to calculate distances between the position of the user and a front wall surface facing the user, a left wall surface positioned at the left of the user, and a right wall surface positioned at the right of the user in each direction, through a distance sensing module; and
a module of correcting distance errors in each direction configured to measure gradients for the front wall surface, the left wall surface, and the right wall surfaces through a gradient sensing module and correct errors for the distances in each direction based on the gradients, when a precision measurement request is received from the user.

10. A method for measuring a position of a light, comprising:
an inputting unit receiving position information on a building and a floor in which a position of a light is to be measured;
a position coordinate calculating unit measuring distances between a position of a user and wall surfaces in the building in each direction and calculating a position coordinate of the user based on the distances in each direction;
a position determining unit applying the position coordinate to a plan view corresponding to the position information to determine an initial position of the user; and
a position information combining unit receiving a light identifier depending on movement of the user and storing position information of the light corresponding to the light identifier.

11. The method for measuring a position of a light of claim 10, wherein the determining of the initial position of the user comprising: a position searching module requesting the user to confirm his/her position when candidate positions corresponding to estimated positions of the user are present, thereby determining the initial position of the user.

12. The method for measuring a position of a light of claim 11, wherein the determining of the initial position of the user comprising: creating reference lines spaced apart from the wall surfaces in the building by the distances in each direction in the plan view and determining contact points between the reference lines to be the candidate positions.

13. The method for measuring a position of a light of claim 11, wherein the determining of the initial position of the user comprising: requesting the user to set the initial position when the candidate positions are not present.

14. The method for measuring a position of a light of claim 10, wherein the storing of the position information of the light comprising: creating a current position coordinate as a light identifier zone boundary line when the light identifier received through a communicating unit depending on the movement of the user is changed.

15. The method for measuring a position of a light of claim 10, wherein the storing of the position coordinate of the light comprising: comparing received powers of the light corresponding to the light identifier with each other and storing a position coordinate at which a received power of the light is maximum as the position information of the light, when the light identifier received through a communicating unit depending on the movement of the user is not changed.

16. The method for measuring a position of a light of claim 10, wherein the determining of the initial position of the user comprising: requesting the user to set a special space including a single light when the special space is present in the plan view.

17. The method for measuring a position of a light of claim 10, wherein the calculating of the position coordinate of the user comprising:
a module of calculating distances in each direction calculating distances between the position of the user and a front wall surface facing the user, a left wall surface positioned at the left of the user, and a right wall surface positioned at the right of the user in each direction, through a distance sensing module; and
a module of correcting distance errors in each direction measuring gradients for the front wall surface, the left wall surface, and the right wall surfaces through a gradient sensing module and correcting errors for the distances in each direction based on the gradients, when a precision measurement request is received from the user.
